(19) United States
(12) Patent Application Publication
(10) Pub. No.: US 2026/0233094 A1
(43) Pub. Date: Aug. 13, 2026

(54) PICTURE DISPLAY METHOD AND APPARATUS, VIDEO PLAYBACK METHOD AND APPARATUS, DEVICE, AND MEDIUM

(71) Applicant: Tencent Technology (Shenzhen) Company Limited, Shenzhen (CN)

(72) Inventor: Jieqi XIE, Shenzhen (CN)

(73) Assignee: Tencent Technology (Shenzhen) Company Limited, Shenzhen (CN)

(21) Appl. No.: 19/638,750

(22) Filed: Apr. 3, 2026

Related U.S. Application Data
(63) Continuation of application No. PCT/CN2025/078569, filed on Feb. 21, 2025.

(30) Foreign Application Priority Data
Feb. 22, 2024 (CN) 202410197684.2

(51) Int. Cl. A63F 13/52; A63F 13/35; A63F 13/533; A63F 13/55; G06F 3/04817; G06F 3/04845; G06F 40/109; G06F 40/169

(52) U.S. Cl. CPC A63F 13/52; A63F 13/533; A63F 13/55; G06F 3/04817; G06F 3/04845; A63F 13/35; G06F 40/109; G06F 40/169; G06F 2203/04806

(57) ABSTRACT

A method and apparatus, and a computer-readable storage medium for an improved picture displaying process is provided. The method is performed by a computer device and applied to a game client. The method displays a virtual screen embedded in a virtual environment. A first playback operation for a first video is received, and the first video is a video from a video playback platform. The first video on the virtual screen is played when the first playback operation is received. At least two bullet comments matching the first video are displayed, and the at least two bullet comments include bullet comments transmitted by objects on the video playback platform and a gaming platform.

### CROSS REFERENCE TO RELATED APPLICATION

This application is a bypass continuation application of International Patent Application No. PCT/CN2025/078569, filed on Feb. 21, 2025, which claims priority to and is based on Chinese Patent Application No. 202410197684.2, filed on Feb. 22, 2024, the disclosures of which are incorporated herein in their entireties by reference.

### FIELD

Embodiments of the present disclosure relate to the field of human-computer interaction, and in particular, to a picture display method and apparatus, a video playback method and apparatus, a device, and a computer readable storage medium.

### BACKGROUND

In the gaming industry, a social interaction function is an important function provided by a gaming platform.

In a related art, an object on one gaming platform can only interact with another object on the same gaming platform, such as forming teams, establishing intimate relationships, or transmitting private messages.

In the related art, social interaction modes that can be provided by the gaming platform are relatively limited, and how to develop more social interaction modes becomes a technical problem that needs to be solved urgently.

### SUMMARY

The present disclosure provides a picture display method and apparatus, a video playback method and apparatus, a device, and a storage medium, and provides an improved cross-platform social interaction solution.

According to an aspect of some embodiments of the present disclosure, a picture display method performed by a computer device and applied to a game client includes: displaying a virtual screen embedded in a virtual environment; receiving a first playback operation for a first video, the first video being a video from a video playback platform; playing the first video on the virtual screen when the first playback operation is received; and displaying at least two bullet comments matching the first video, the at least two bullet comments comprising bullet comments transmitted by objects on the video playback platform and a gaming platform.

According to an aspect of some embodiments of the present disclosure, a picture display apparatus, a game client being installed on the picture display apparatus, includes: at least one memory configured to store program code; and at least one processor configured to read the program code and operate as instructed by the program code, the program code including: a first display code configured to cause the at least one of the at least one processor to display a virtual screen embedded in a virtual environment; and a receiving code configured to cause the at least one of the at least one processor to receive a first playback operation for a first video, the first video being a video from a video playback platform, a playing code configured to cause the at least one of the at least one processor to play the first video on the virtual screen when the first playback operation is received; and a second display code configured to cause the at least one of the at least one processor to display at least two bullet comments matching the first video, and the at least two bullet comments comprising bullet comments transmitted by objects on the video playback platform and a gaming platform.

According to an aspect of some embodiments of the present disclosure, a non-transitory computer-readable storage medium, storing computer code, the computer code which, when executed by at least one processor, causes the at least one processor to at least: display a virtual screen embedded in a virtual environment; receive a first playback operation for a first video, the first video being a video from a video playback platform; play the first video on the virtual screen when the first playback operation is received; and display at least two bullet comments matching the first video, the at least two bullet comments comprising bullet comments transmitted by objects on the video playback platform and a gaming platform.

According to an aspect of some embodiments of the present disclosure, a video playback method, the method being performed by a computer device and being applied to a video playback client, the video playback client being supported by a video playback platform including: receiving a second playback operation for a first video; and playing the first video when the second playback operation is received, and displaying at least two bullet comments matching the first video, the first video supporting playback on a virtual screen embedded in a virtual environment provided by a gaming platform, and the at least two bullet comments comprising the bullet comments transmitted by objects on the video playback platform and the gaming platform. The method includes displaying information of an object transmitting a first bullet comment on the gaming platform when the first bullet comment receives a trigger operation for the first bullet comment of the at least two bullet comments, the first bullet comment being transmitted by an object on the gaming platform. The method includes displaying a following button when the first bullet comment receives a trigger operation and in a case that the first bullet comment is transmitted by a first creation object, the first creation object being a creation object whose number of followers on the gaming platform is greater than a number threshold, and the creation object being an object creating a game level; and jumping to a game client supported by the gaming platform when the following button receives a trigger operation, to establish a following relationship between the object logged in to the game client and the first creation object.

According to an aspect of some embodiments of the present disclosure, a picture display apparatus, a game client being installed on the apparatus, including: a display code, configured to display a virtual screen embedded in a virtual environment; and a receiving code, configured to receive a first playback operation for a first video, the first video being a video from a video playback platform, the display code being further configured to play the first video on the virtual screen when the first playback operation; and the display code being further configured to display at least two bullet comments matching the first video, and the at least two bullet comments comprising the bullet comments transmitted by objects on the video playback platform and a gaming platform.

Technical solutions provided by the embodiments of the present disclosure have at least the following beneficial effects:

The first video is played on the virtual screen, at least two bullet comments matching the first video are displayed, and the at least two bullet comments include the bullet comments transmitted by the objects on the video playback platform and the gaming platform. To be specific, the present disclosure provides a cross-platform social interaction solution implemented based on the bullet comments. The game interface may display the bullet comments transmitted by the object on the video playback platform, so that the subsequent cross-platform social interaction may be implemented based on the bullet comments, thereby improving cross-platform social interaction efficiency between different platforms. Namely, users on both the gaming platform and the video playback platform may transmit the bullet comments for the first video to perform cross-platform interaction, thereby reducing a data interaction volume between terminals and between servers in a cross-platform social interaction process, and improving data interaction efficiency.

### BRIEF DESCRIPTION OF DRAWINGS

To describe the technical solutions in the embodiments of the present disclosure more clearly, the following briefly describes the accompanying drawings required for describing the embodiments of the present disclosure. The accompanying drawings in the following description show only some embodiments of the present disclosure, and a person of ordinary skill in the art may still derive other drawings from these accompanying drawings without creative efforts. In addition, one of ordinary skill would understand that aspects of some embodiments may be combined together or implemented alone.

FIG. 1A is a schematic diagram of a picture display process according to an embodiment.

FIG. 1B is a schematic diagram of a picture display process according to another embodiment.

FIG. 2 is a flowchart of a picture display method according to an embodiment.

FIG. 3 is a schematic diagram of a game interface according to an embodiment.

FIG. 4 is a flowchart of a picture display method according to an embodiment.

FIG. 5 is a flowchart of a bullet comment display mode according to an embodiment.

FIG. 6 is a schematic diagram of a bullet comment display mode according to an embodiment.

FIG. 7 is a flowchart of a bullet comment display mode according to an embodiment.

FIG. 8 is a schematic diagram of a game interface according to an embodiment.

FIG. 9 is a schematic diagram of a bullet comment display mode according to an embodiment.

FIG. 10 is a schematic diagram of a bullet comment display mode according to an embodiment.

FIG. 11 is a schematic diagram of a game interface according to an embodiment.

FIG. 12 is a flowchart of a video playback method according to an exemplary embodiment.

FIG. 13 is a schematic diagram of a change process of content displayed by a terminal according to an embodiment.

FIG. 14 is a flowchart of a picture display method according to an embodiment.

FIG. 15 is a flowchart of a picture display method according to an embodiment.

FIG. 16 is a flowchart of a picture display method according to an embodiment.

FIG. 17 is a flowchart of a picture display method according to an embodiment.

FIG. 18 is a structural block diagram of a picture display apparatus according to an embodiment.

FIG. 19 is a structural block diagram of a video playback apparatus according to an embodiment.

FIG. 20 is a structural block diagram of a computer device according to an embodiment.

### DETAILED DESCRIPTION

Terms involved in embodiments of the present disclosure are briefly introduced.

A virtual environment is an environment displayed (or provided) when an application program is run on a terminal. The virtual environment may be a simulated environment of a real world, a semi-simulated and semi-fabricated virtual world, or a completely fabricated virtual world. The virtual environment may be any one of a two-dimensional virtual environment, a 2.5-dimensional virtual environment, or a three-dimensional virtual environment. Dimensionality of the virtual environment is not limited in the embodiments of the present disclosure. For example, the virtual environment may include sky, land, an ocean, or the like, the land may include an environment element such as a desert or a city, and the virtual world includes at least one virtual item.

Virtual character: a virtual character refers to a movable character in the virtual environment. The movable character may be a virtual figure, a virtual animal, an animation figure, or the like, such as a figure, an animal, and an elf displayed in the virtual environment. In some embodiments, the virtual character is a three-dimensional model created based on an animation skeleton technology. Each virtual character has a shape and a size in a three-dimensional virtual environment, and occupies a part of space of the three-dimensional virtual environment.

Object: in the present disclosure, an object on a gaming platform refers to a player or a player account on the gaming platform. The object on a video playback platform is a user or a user account on the video playback platform.

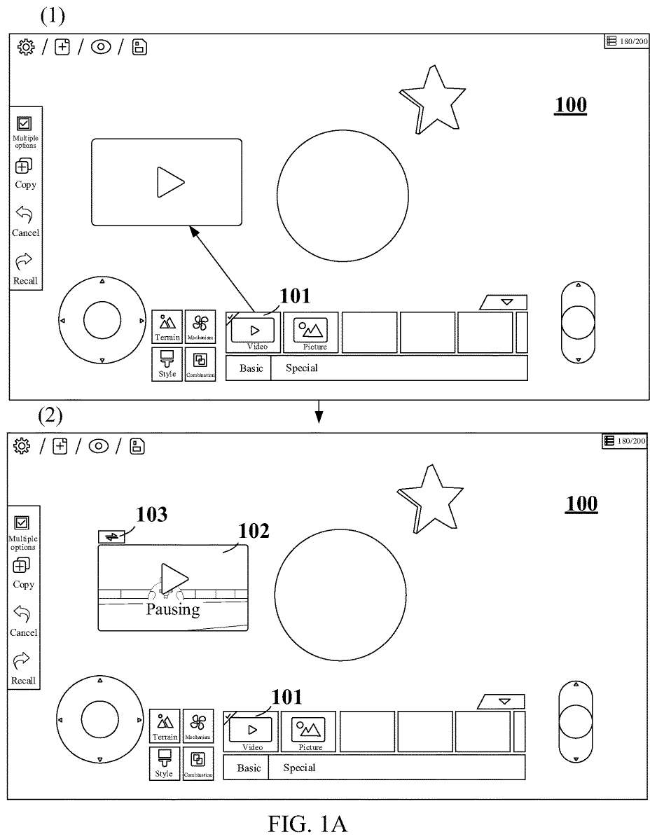

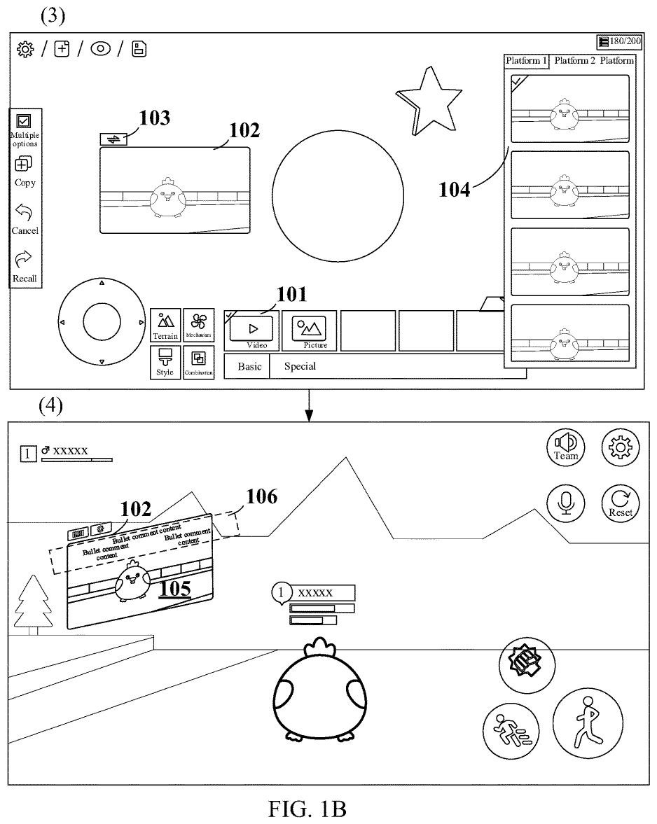

FIGS. 1A and 1B are schematic diagrams of a picture display process according to an exemplary embodiment of the present disclosure. Part (1) of FIG. 1A shows an editing interface 100 of a virtual environment. The virtual environment is an environment supporting customized setup of an object. In some embodiments, the virtual environment is an environment belonging to a particular object. In some cases, the virtual environment is an environment of a level built by the object. Various components, such as a terrain component, a mechanism component, a style component, and a composite component, are provided in the editing interface 100 of the virtual environment. The mechanism component includes a video control 101. When the video control 101 receives a dragging operation and is dragged to a placeable area in a preview scenario, a virtual screen is displayed in the preview scenario.

Part (2) of FIG. 1A shows a virtual screen 102 in a preview scenario. The virtual screen 102 is used as a video carrier and configured to play a video. In some embodiments, a switch button 103 is further displayed around the virtual screen 102, and a video source pop-up window is displayed when the switch button 103 receives a trigger operation.

Part (3) of FIG. 1B shows a video source pop-up window 104. The video source pop-up window 104 displays options of a plurality of video playback platforms (a platform 1, a platform 2, a platform 3, and the like). The video source pop-up window 104 further displays a replaceable video on each video playback platform. The object may change the video playback platform and a played program in the video source pop-up window 104.

After the virtual environment is edited, part (4) of FIG. 1B is a schematic diagram of a virtual environment in a gaming process. Part (4) of FIG. 1B shows a virtual screen 102 embedded in a virtual environment, a first video 105 played on the virtual screen 102, and at least two bullet comments 106 matching the first video 105. The first video 105 is a video from a set video playback platform. The at least two bullet comments 106 include a bullet comment transmitted by an object on the video playback platform and a bullet comment transmitted by an object on a gaming platform.

In an embodiment, the picture display method shown in FIGS. 1A and 1B is performed by a computer device. The computer device includes at least one of a terminal device and a server.

In an embodiment, a game client is installed and run on the terminal device. The game client may be any one of a massively multiplayer party game, a turn-based game, a massively multiplayer online game (MMOG), a role-playing game (RPG), a three-dimensional map program, a virtual reality (VR) application program, and an augmented reality (AR) program. In some embodiments, the terminal device is further connected with an external connection device, such as a mouse, a keyboard, a handle, a sound unit, VR/AR glasses, or a VR/AR helmet.

The terminal device is connected to the server over a wireless network or a wired network.

The server includes at least one of one server, a plurality of servers, a cloud computing platform, and a virtualization center. For example, the server includes a processor and a memory. The memory further includes a receiving module, a control module, and a transmitting module. The receiving module is configured to receive a request transmitted by a client, such as a team forming request. The control module is configured to control rendering of a virtual environment picture. The transmitting module is configured to transmit a response to the client, such as transmitting prompt information indicating a success in team formation to the client. The server is configured to provide a background service for an application program supporting a three-dimensional virtual environment. In some embodiments, the server takes on primary computing work, and the terminal device takes on secondary computing work; or the server takes on the secondary computing work, and the terminal device takes on the primary computing work; or collaborative computing is performed by using a distributed computing architecture between the server and the terminal device.

In some embodiments, application programs installed on the terminal device are application programs on different operating system platforms (such as Windows, Mac, and Linux). The terminal device may refer to one of a plurality of terminals. The terminal is only used as an example for description in the embodiment. A device type of the terminal device includes: at least one of a desktop computer, a laptop portable computer, a smart-phone, a smart television, a wearable device, a tablet computer, an in-vehicle terminal, an e-book reader, an MP3 player, or an MP4 player.

A person skilled in the art knows that the number of the above terminals may be more or less. For example, the number of the foregoing terminal may be only one, or the number of foregoing terminals is dozens or hundreds, or more. The embodiments of the present disclosure do not limit the number and device type of the terminal.

Information (including but not limited to user equipment information, user personal information, and the like), data (including but not limited to data for analysis, stored data, displayed data, and the like), and signals in the present disclosure are all authorized by users or fully authorized by all parties, and collection, use, and processing of related data need to comply with relevant laws, regulations, and standards of relevant countries and regions.

In addition, for the related information involved in the present disclosure, a processor of the related information clarifies an objective, manner, and scope of processing the related information by following legal, justified, and necessary principles, obtains the consent of a subject of the related information, and takes necessary technical and organizational measures to ensure the security of the related information.

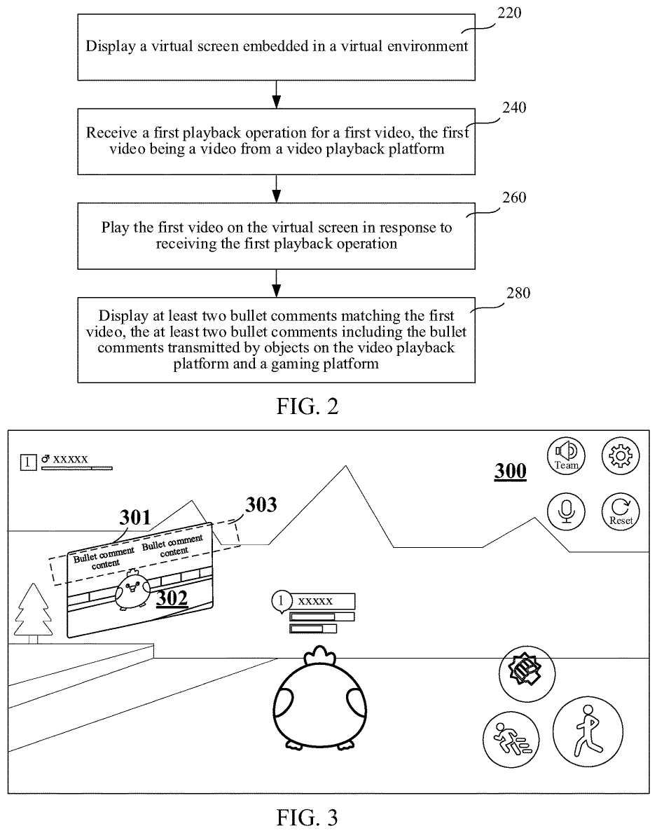

FIG. 2 is a flowchart of a picture display method according to an exemplary embodiment of the present disclosure. The method is applied to a game client. An example in which the method is performed by a computer device is used for description. The method includes the following operations:

Operation 220: Display a virtual screen embedded in a virtual environment.

In some embodiments, the virtual environment is a basic environment designed by a game developer, and a player cannot cause a permanent change to the virtual environment. For example, a virtual character controlled by the player damages a “wall” in a battle, but the wall may appear as an original shape in another battle. In some embodiments, the virtual environment is an environment supporting an editing operation of the player. The editing interface provides various environment components, and the player may edit terrain, mechanisms, styles, and the like of the virtual environment in the editing interface. To be specific, the virtual environment is a user generated content (UGC) environment. In this embodiment of the present disclosure, the virtual environment is presented by the game client provided by the gaming platform.

In some embodiments, the virtual environment is an environment belonging to a particular object. For example, the virtual environment is an environment of a level built by an object A. In some embodiments, the level may be referred to as a “home”, a “paradise”, and the like of the object A.

In some embodiments, the game client is a client of a party game. In the party game, the player may customize and build a level. After completion, the player may post the level or invite other virtual characters to view (experience) it. Multiple virtual characters enter the level, and carry out activities in the virtual environment of the level.

The virtual screen is configured to accommodate a video carrier of a video. In some embodiments, an operation of building a video control in the virtual environment is received in an editing interface of the virtual environment, and after the video control is built, the virtual screen embedded in the virtual environment is displayed. In some embodiments, an embedding position of the virtual screen may be changed by dragging the video control. In some embodiments, the virtual screen is presented as a theater projection curtain, a television screen, a computer screen, or the like.

In an embodiment, the virtual environment may be a three-dimensional virtual environment, a two-dimensional virtual environment, a 2.5-dimensional virtual environment, or the like. In some embodiments, the virtual environment is a three-dimensional virtual environment, and the virtual screen is a three-dimensional screen embedded in the three-dimensional virtual environment.

Operation 240: Receive a first playback operation for a first video, the first video being a video from a video playback platform.

The first playback operation is configured to control the virtual screen to play the video. In some embodiments, the first playback operation is implemented as at least one of an operation triggered by a control, an operation triggered by a gesture, an operation triggered by a shortcut key, or an operation triggered by a user voice. This is not limited herein. In some embodiments, when the first playback operation is implemented as the operation triggered by the gesture, the first playback operation may be implemented as a long-press operation, a click/tap operation, a drag operation, a re-click/re-tap operation, a double-click/double-tap operation, or the like. This is not limited herein.

In some embodiments, an example in which the first playback operation is triggered by the control is used. For example, the first video is played when a video playback button corresponds to the virtual screen receives a trigger operation. The detection of the trigger operation for the video playback button is implemented as follows: when a user touches a screen of a terminal, a sensor of the screen may detect a capacitance change of a touch point, and converts the capacitance change into a coordinate signal; and when a coordinate position indicated by the coordinate signal falls within a button coordinate range in which the video playback button is located, whether the trigger operation for the video playback button is received is determined based on the coordinate signal. For example, using an example in which the trigger operation is implemented as the long-press operation, whether the trigger operation for the video playback button is received is determined by whether duration, when the coordinate signal is located in the button coordinate range, reaches a preset duration threshold.

In some embodiments, a display position of the video playback button may be implemented as at least one of the following: displayed around the virtual screen; and displayed at a specified position (including a system preset position and an object customized position) on a game interface.

In some embodiments, the first video is video content set when the virtual screen is built. For example, when the virtual screen is built, a video setting operation for the virtual screen is received. The video setting operation instructs to set the video content played on the virtual screen to the first video; or the first video is video content selected by an object instructing the first playback operation. For example, an interaction operation on the virtual screen is received, a plurality of candidate videos are displayed when the interaction operation is received, and the first playback operation of selecting the first video from the plurality of candidate videos is received.

Operation 260: Play the first video on the virtual screen when receiving the first playback operation.

In some embodiments, a playback authority of the first video may be implemented as at least one of the following: each player independently controls a device of the player to play or not play the first video; and/or, an object of an associated virtual character is controlled to have an authority to play or not play the video, and the associated virtual character is a virtual character to which the current virtual environment belongs, for example, the associated virtual character may be implemented as a “homeowner”.

In an embodiment, when a virtual character located in the virtual environment moves around the virtual screen, a video playback button is displayed, and when the video playback button receives a trigger operation, the first video is played. In this case, each player may independently control their own device to play or not play the first video.

In another embodiment, when the associated virtual character of the virtual environment moves around the virtual screen, the video playback button is displayed. When the video playback button receives a trigger operation of an object controlling the associated virtual character, the video is played. The associated virtual character of the virtual environment may select a to-be-played video and/or a video playback platform. In this case, only the object controlling the associated virtual character has the authority to play or not play the video. The virtual characters in the virtual environment watch a same video together, or do not watch the video together.

The video playback platform refers to a platform having a video playback function. The video playback platform supports video playback in at least one of the following forms: browser web pages, clients, mini-programs, etc. The first video is a video selected for playback. When the game client receives a selection operation of the first video, source data of the first video and bullet comment data matching the first video on the video playback platform are acquired from the video playback platform.

In an embodiment, the first video is stored in a video server corresponding to the video playback platform. After receiving the first playback operation for the first video, the game client transmits an acquisition request for the first video to the video server. The video server transmits the source data and bullet comment data of the first video to the game client when the acquisition request is transmitted.

In some embodiments, the game client acquires the source data and the bullet comment data of the first video by using an application programming interface (API) provided by the video server; or, the game client acquires the source data and the bullet comment data of the first video from the video server using the file transfer protocol (FTP) or the secure file transfer protocol (SFTP); or the game client acquires the source data and the bullet comment data of the first video from the video server using the hyper text transfer protocol (HTTP) or the hyper text transfer protocol secure (HTTPS).

In some embodiments, the video server provides streaming media data of the first video to the game client, or the video server provides a video file of the first video to the game client.

Operation 280: Display at least two bullet comments matching the first video, the at least two bullet comments including the bullet comments transmitted by objects on the video playback platform and a gaming platform.

When the video is played, at least two bullet comments matching the first video are displayed. The at least two bullet comments include the bullet comment transmitted by a user/user account on the video playback platform and a bullet comment transmitted by a player/player account on the gaming platform. In an embodiment, when the video is played, the bullet comment transmitted by the object corresponding to the virtual character located in the virtual environment is displayed. In some embodiments, the bullet comment from the video playback platform includes at least one of text, a picture, and an emoticon. In some embodiments, the bullet comment from the gaming platform includes at least one of text, a picture, and an emoticon.

FIG. 3 shows a virtual environment 300 and a virtual screen 301 embedded in the virtual environment 300. A first video 302 is played on the virtual screen 301. In this case, at least two bullet comments 303 matching the first video 302 are further displayed on the virtual screen 301.

In some embodiments, during the playback of the first video, at least two bullet comments matching the first video are displayed by default; or during the playback of the first video, a bullet comment enabling operation is received, and when receiving the bullet comment enabling operation, at least two bullet comments matching the first video are displayed.

In some embodiments, the bullet comment enabling operation is implemented as at least one of an operation triggered by a control, an operation triggered by a shortcut key, and an operation triggered by a user voice. This is not limited herein.

In an embodiment, while the current object logged in to the game client is in the virtual environment, the bullet comments transmitted by object on the gaming platform are updated in real time. The at least two bullet comments include the bullet comment transmitted by the object on the gaming platform, and the terminal device acquires and displays, in real time, the bullet comments transmitted by the object on the gaming platform.

In a case that the current object re-enters the virtual environment, an updated bullet comment is pulled from the video playback platform, and the updated bullet comment is displayed. The at least two bullet comments include the bullet comment transmitted by the object on the video playback platform, and the bullet comment from the video playback platform is not updated in real time, but is updated only when the object enters the virtual environment.

The bullet comment on the gaming platform can be updated in real time, and the bullet comment on the video playback platform cannot be updated in real time, thereby ensuring a real-time display demand of the bullet comment on the terminal device. The bullet comment is acquired across platforms in real time, which has relatively high requirements on the terminal device and the network. For the same platform, background data of the platform is stored in relatively close or identical servers or server clusters, while background data of different platforms tends to be stored in the servers that are far from each other. Acquiring the bullet comment data simultaneously from both the gaming platform and the video playback platform in real time inevitably requires high network performance, which, for viewers with poor network connections, affects the experience of viewing the bullet comments.

Operation 260 and operation 280 may be performed simultaneously. To be specific, when the first video starts to be played, at least two bullet comments matching the first video are displayed at the same time. Alternatively, operation 280 is performed in a process of performing operation 260, namely, the at least two bullet comments matching the first video are displayed in a process of playing the first video.

In conclusion, the first video is played on the virtual screen, the at least two bullet comments matching the first video are displayed, and the at least two bullet comments include the bullet comments transmitted by the objects on the video playback platform and the gaming platform. To be specific, the present disclosure provides a cross-platform social interaction solution implemented based on the bullet comments. The game interface may display the bullet comments transmitted by the object on the video playback platform, so that the subsequent cross-platform social interaction may be implemented based on the bullet comments, thereby improving cross-platform social interaction efficiency between different platforms. Namely, users on both the gaming platform and the video playback platform may transmit the bullet comments for the first video to perform cross-platform interaction, thereby reducing a data interaction volume between terminals and between servers in a cross-platform social interaction process, and improving data interaction efficiency.

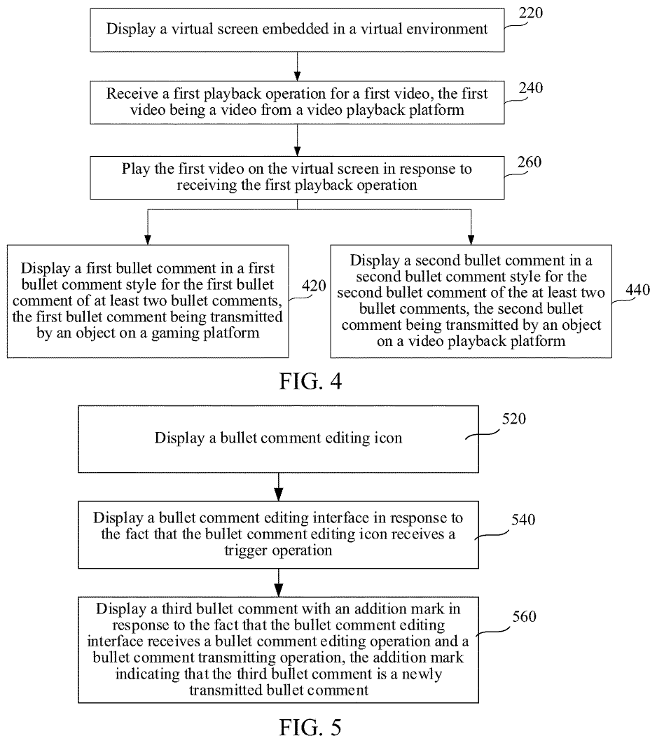

In this embodiment of the present disclosure, the bullet comment from the video playback platform and the bullet comment from the gaming platform may be displayed distinctively or not displayed distinctively. FIG. 4 shows a process of a distinctive display method.

Based on an exemplary embodiment shown in FIG. 2, operation 280 includes method operations shown in FIG. 4. FIG. 4 is a flowchart of a bullet comment display method according to an exemplary embodiment of the present disclosure. An example in which the method is performed by a computer device is used for description. The method includes the following operations:

Operation 420: Display a first bullet comment in a first bullet comment style for the first bullet comment of the at least two bullet comments, the first bullet comment being transmitted by an object on a gaming platform.

The first bullet comment style has at least one of a bullet comment special effect, a pattern, a border, a font, a color, a font size, and source information. The first bullet comment style includes at least one of the following four display modes.

First possible display mode: the virtual environment has a plurality of seats located around the virtual screen. For example, the virtual screen is a projection curtain in a living room, and a left sofa, a couch (including two or more seats), and a right sofa further exist in the living room. In a case that the first bullet comment is sourced from a first object located at the first seat, first seat information and content of the first bullet comment are displayed, and the first seat information is related information of the first seat. For example, the first seat information includes a name, a pattern, and the like of the first seat.

For example, the first bullet comment is presented as “left sofa: this drama is really good”. By displaying the seat information, another object watching the first video may quickly and clearly identify a bullet comment transmitting object, thereby interacting with the bullet comment transmitting object, such as establishing an intimate relationship, forming a team, or engaging in private chat with the bullet comment transmitting object. Another object watching the first video may control the virtual character to move around the first seat, and contend with the virtual character at the first seat for the first seat, or the like. If the bullet comment gains widespread attention, more virtual characters are attracted to move around the first seat, to form an interaction circle, thereby promoting interaction among the virtual characters.

Second possible display mode: a first bullet comment having a first style border is displayed, and the first style border is associated with a building style of the virtual environment.

For example, the building style of the virtual environment is a first building style of a plurality of preset building styles. The first bullet comment having the first style border is displayed, and the first style border corresponds to the first building style.

For example, the virtual environment is an environment supporting object editing. The virtual environment is an environment belonging to a particular object, and may be referred to as a “home”, a “paradise”, or the like of the object. When the associated object initially creates the virtual environment or changes the building style of the virtual environment, the building style for the virtual environment may be selected from multiple building styles (such as Bamboo Courtyard, Fairytale Town, Fantasy Romance, etc.). The first bullet comment may have a first style border, the first style border corresponds to the first building style, and the first building style is a building style of the current virtual environment. For example, if the first building style is “bamboo courtyard”, the first style border is a border surrounded by vines.

In the second possible display mode, display styles of the first bullet comments are enriched, so that the bullet comment from the gaming platform is easily distinguished by the viewer from the bullet comment from the video playback platform.

Third possible display mode: When a number of virtual characters accommodated in the virtual environment is within a first number range, the first bullet comment with a first dynamic special effect is displayed, and the first dynamic special effect corresponds to the first number range. As the number of virtual characters accommodated in the virtual environment increases, the dynamic special effects have more elaborate visual effects.

For example, when the virtual environment accommodates two virtual characters, falling within a number range (1 to 3), the first bullet comment with a dynamic special effect of “faint firelight” is displayed; and in addition to the bullet comment content, the visual special effect of “faint firelight” further presents at a position of the first bullet comment.

For example, when the virtual environment accommodates 5 virtual characters, falling within a number range (4 to 7), a first bullet comment with a dynamic special effect of “burning flame” is displayed; and in addition to the bullet comment content, the visual special effect of “burning flame” further presents at the position of the first bullet comment.

For example, when the virtual environment accommodates 10 virtual characters, falling within a number range (8 to 11), the first bullet comment with a dynamic special effect of “blazing fire” is displayed; and in addition to the bullet comment content, a visual special effect of “blazing fire” further presents at the position of the first bullet comment.

In the third possible display mode, the display styles of the first bullet comment are enriched, so that the bullet comment from the gaming platform is easily distinguished by the viewer from the bullet comment from the video playback platform. Moreover, the virtual environment is an environment of a level, and the virtual environment is an environment created by a level creator. Displaying the dynamic special effect based on the number of virtual characters accommodated in the virtual environment is conducive to enhancing the sense of achievement for the level creator, encouraging the level creator to create a better level, and attracting more virtual characters to view/challenge the level.

Fourth possible display mode: a virtual environment is an environment customized by an associated object. In a case that the first bullet comment is from a second object, the first bullet comment having a first relationship border is displayed, the second object on the gaming platform has a first intimate relationship with the associated object, and the first relationship border is a border corresponding to the first intimate relationship.

For example, the first bullet comment is from an object having a “couple” relationship with the associated object. The first bullet comment has a “couple” relationship border, such as a heart-shaped border and a pink bubble border.

For example, the first bullet comment is from an object having a “partner” relationship with the associated object. The first bullet comment has a “partner” relationship border, such as a fist-shaped border, and a handshake border.

Various social relationships of the associated object and views of the various social relationships on events in the video may be clearly and quickly learned by another object based on the border type of the bullet comment, to facilitate next interaction. For example, the bullet comment transmitted by a “partner” of the associated object attracts widespread attention, and an object controlling another virtual character may actively find the “partner” by using a profile page of the object, and apply to be added as a friend.

Operation 440: Display a second bullet comment in a second bullet comment style for the second bullet comment of the at least two bullet comments, the second bullet comment being transmitted by an object on the video playback platform.

The second bullet comment has a bullet comment style having at least one of a bullet comment special effect, a pattern, a border, a font, a color, a font size, and source information. The first bullet comment style and the second bullet comment style are distinctive bullet comment styles having at least one of a bullet comment special effect, a pattern, a border, a font, a color, a font size, and source information.

In an embodiment, in a case that the second bullet comment is from a third object on the video playback platform, level information of the third object on the video playback platform and content of the second bullet comment are displayed. For example, if an account level of the third object on the video playback platform is V5, the second bullet comment having a V5 mark is displayed.

In conclusion, the foregoing provides a solution for distinguishing the bullet comment from the gaming platform and the bullet comment from the video playback platform, and provides a possible display mode of the first bullet comment and second bullet comment. To be specific, the bullet comments from different platforms are displayed using different bullet comment styles, so that the user can quickly learn a bullet comment source based on the bullet comment display style, thereby improving transmission efficiency of bullet comment information, and facilitating the user to make a decision about the bullet comment for subsequent social interaction. For example, when social interaction needs to be performed with another user on the same gaming platform, interaction is performed on the first bullet comment of the first bullet comment style, and when cross-platform social interaction needs to be performed with another user on the video platform, interaction is performed on the second bullet comment of the second bullet comment style, which can reduce human-computer interaction operations that need to be performed when the user makes a decision, thereby improving human-computer interaction efficiency, and reducing a detection demand of the terminal for the user operation.

In an embodiment, the game client provides a bullet comment editing function to a user by displaying a bullet comment editing icon. FIG. 5 is a flowchart of a bullet comment display mode according to an exemplary embodiment of the present disclosure. An example in which the bullet comment display mode is executed by a computer device is used for description. The method includes the following operations:

Operation 520: Display a bullet comment editing icon.

The bullet comment editing icon is configured to provide a bullet comment editing function for a first video, is a control that is displayed in an interface to implement user interaction, and can receive an input signal and open a bullet comment editing interface based on the input signal to provide the bullet comment editing function.

In some embodiments, the bullet comment editing icon is displayed around a virtual screen. For example, the bullet comment editing icon is displayed above the virtual screen. Alternatively, the bullet comment editing icon is displayed inside the virtual screen, for example, a bullet comment marking icon is displayed at a lower right corner of the virtual screen. Alternatively, the bullet comment editing icon is displayed at a specified position on a game interface. For example, the bullet comment editing icon is displayed at an upper left corner of the game interface.

In an embodiment, a virtual screen is embedded in the virtual environment, and the bullet comment editing icon is displayed around the virtual screen. In some embodiments, the bullet comment editing icon is presented as a keyboard pattern or the like.

Operation 540: Display a bullet comment editing interface when the bullet comment editing icon receives a trigger operation.

In some embodiments, the trigger operation for the bullet comment editing icon may be implemented as a long-press operation, a click/tap operation, a drag operation, a re-click/re-tap operation, a double-click/double-tap operation, or the like. This is not limited herein.

The bullet comment editing interface is displayed when the bullet comment editing icon receives the trigger operation. For example, the trigger operation includes any one of a click/tap operation, a long-press operation, and an operation of dragging to the virtual screen. For example, when the bullet comment editing icon receives the trigger operation, the game interface invokes an input method keyboard. In some embodiments, the input method keyboard supports at least one of a text input, an emoticon input, a picture input, and a voice input.

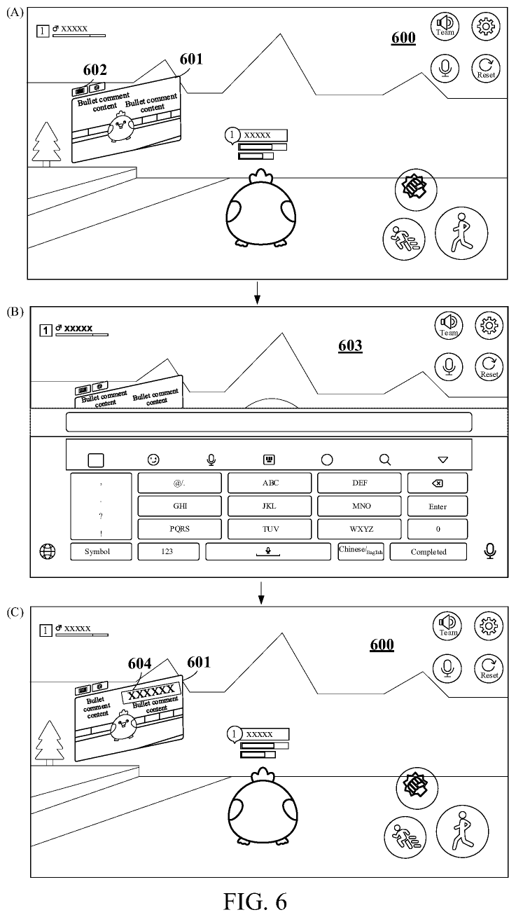

Part (A) of FIG. 6 shows a virtual environment 600 according to an exemplary embodiment of the present disclosure. A virtual screen 601 is embedded in the virtual environment 600, and a bullet comment editing icon 602 is displayed around the virtual screen 601. When the bullet comment editing icon 602 receives a click/tap operation, a bullet comment editing interface is displayed.

Part (B) of FIG. 6 shows a bullet comment editing interface 603 according to an exemplary embodiment of the present disclosure.

Operation 560: Display a third bullet comment with an addition mark when a bullet comment editing interface receives a bullet comment editing operation and a bullet comment transmitting operation, the addition mark indicating that the third bullet comment is a newly transmitted bullet comment.

The third bullet comment is edited through the bullet comment editing operation and displayed through the bullet comment transmitting operation. The addition mark includes adding a white border, adding a temporary flickering special effect, giving a temporary distinctive color to the bullet comment, and the like.

Part (C) of FIG. 6 shows a virtual environment 600, and a virtual screen 601 in the virtual environment 600. In this case, a third bullet comment 604 is displayed on the virtual screen 601, and the third bullet comment has an addition mark (a white border).

In conclusion, the foregoing embodiment provides a solution for a player to edit the bullet comment. Specifically, by displaying the bullet comment editing interface through the bullet comment editing icon and adding the addition mark for the newly transmitted bullet comment, the object on the gaming platform may interact with the object on the video playback platform through the bullet comment, thereby improving the interaction experience of the player, and improving diversity of human-computer interaction.

In an embodiment, the game client provides a setting function of a bullet comment display style to a user by displaying a bullet comment setting icon. For example, the bullet comment setting icon is displayed. A bullet comment setting pop-up window is displayed when the bullet comment setting icon receives a trigger operation; and at least one bullet comment style of at least two bullet comments is updated and displayed when the bullet comment setting pop-up window receives at least one setting operation.

In some embodiments, the trigger operation for the bullet comment setting icon may be implemented as a long-press operation, a click/tap operation, a drag operation, a re-click/re-tap operation, a double-click/double-tap operation, or the like. This is not limited herein.

In some embodiments, the at least one setting operation includes a setting operation for a bullet comment color, a setting operation for a bullet comment font, a setting operation for a bullet comment font size, a setting operation for a bullet comment display position, and the like.

FIG. 7 is a flowchart of a bullet comment display mode according to an exemplary embodiment of the present disclosure. An example in which the bullet comment display mode is executed by a computer device is used for description. Control objects of all virtual characters in a virtual environment may execute the bullet comment display mode described below, or only an associated object of the virtual environment may execute the bullet comment display mode described below. This is not limited in the present disclosure. The method includes:

Operation 710: Display a bullet comment setting pop-up window when a bullet comment setting icon receives a trigger operation.

In this embodiment of the present disclosure, a virtual screen is embedded in a virtual environment, and a bullet comment setting icon is displayed around the virtual screen. The bullet comment setting pop-up window is displayed when the bullet comment setting icon receives the trigger operation. For example, the trigger operation includes any one of a click/tap operation, a long-press operation, and an operation of dragging to the virtual screen.

The bullet comment setting pop-up window supports setting of at least one of the following: a color, font, font size, display position, and container of the bullet comment. The above settings are described in detail below. For ease of description, it is assumed that the at least two bullet comments currently have a first color, a first font, a first font size, a first position in the container, and a position on the virtual screen.

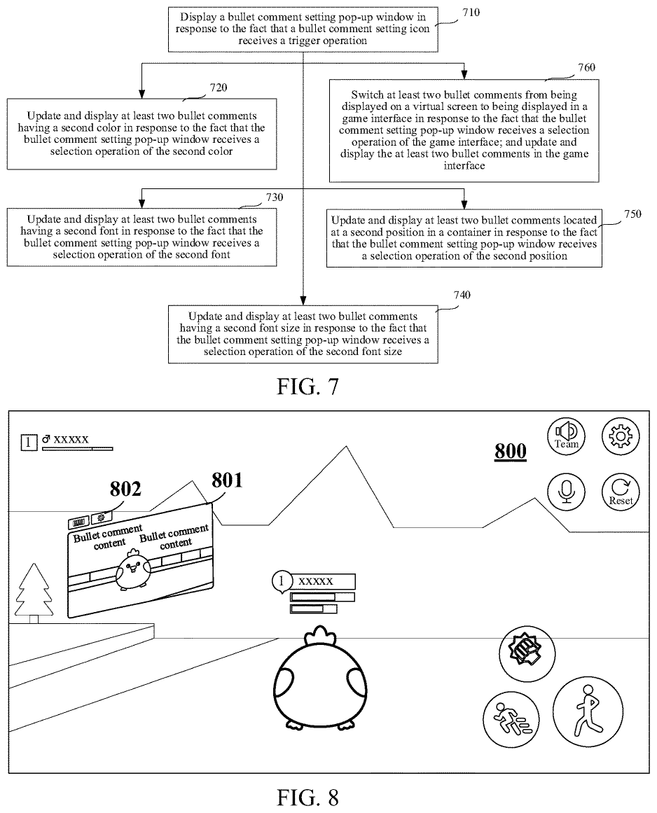

FIG. 8 is a schematic diagram of a game interface according to an exemplary embodiment of the present disclosure. A virtual environment 800, a virtual screen 801 located in the virtual environment 800, and a bullet comment setting icon 802 located around the virtual screen 801 are displayed in the game interface. The bullet comment setting pop-up window is displayed when the bullet comment setting icon 802 receives a click/tap operation.

Operation 720: Update and display at least two bullet comments having a second color when the bullet comment setting pop-up window receives a selection operation of the second color.

The at least two bullet comments have the first color before the color is changed, and when the bullet comment setting pop-up window receives the selection operation of the second color, the at least two bullet comments having the second color are updated and displayed.

Color cubes of a plurality of color styles are displayed in the bullet comment setting pop-up window, to facilitate a player to distinguish the colors and accurately determine a to-be-set bullet comment color. In some embodiments, if a color cube of the second color in the bullet comment setting pop-up window is selected, the color of the bullet comment is changed into the second color in real time.

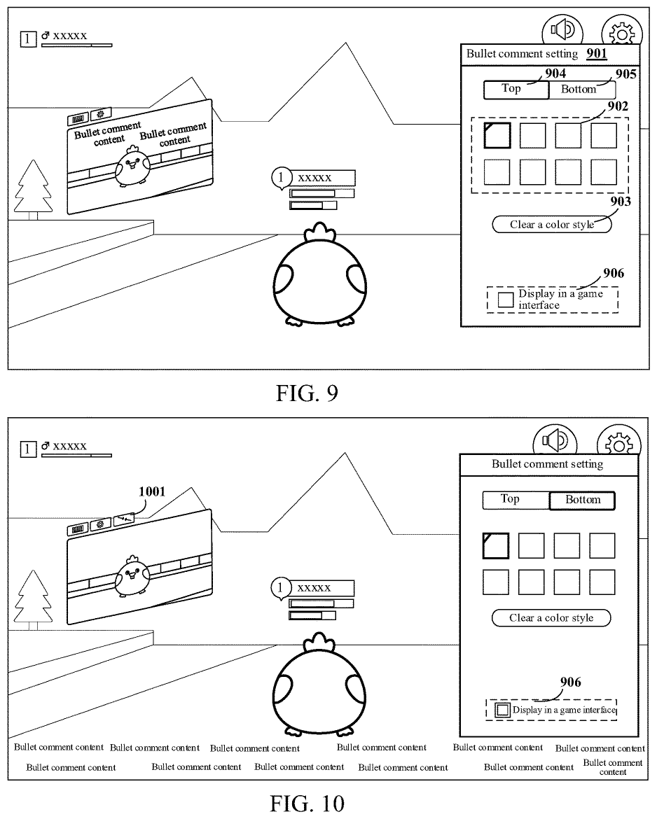

FIG. 9 shows a bullet comment setting pop-up window 901 according to an exemplary embodiment of the present disclosure. A plurality of color cubes 902 are displayed in the bullet comment setting pop-up window 901, and the plurality of color cubes 902 correspond one-to-one with a plurality of color styles. When any one of color cubes 902 receives a click/tap operation, a color corresponding to the color cube 902 is selected. The bullet comment setting pop-up window 901 further displays a button 903 of “clearing the color style”, to facilitate the player to quickly restore an initial color of the bullet comment.

Operation 730: Update and display at least two bullet comments having a second font when a bullet comment setting pop-up window receives a selection operation of the second font.

The at least two bullet comments have a first font before the font is changed. The at least two bullet comments with the second font are updated and displayed when the bullet comment setting pop-up window receives the selection operation of the second font. The font may be a standard font, a personalized font, or the like. The font may be personalized by a virtual character in the virtual environment based on own needs, capabilities, and the like.

Operation 740: Update and display at least two bullet comments having a second font size when the bullet comment setting pop-up window receives a selection operation of the second font size.

The at least two bullet comments have a first font size before the font size is changed. The at least two bullet comments with the second font size are updated and displayed when the bullet comment setting pop-up window receives the selection operation of the second font size. The font size may be a standard font size, a smaller font size, a larger font size, or the like. The font size may be personalized by a virtual character in the virtual environment based on one's own needs, capabilities, and the like.

Operation 750: Update and display at least two bullet comments located at a second position in a container when the bullet comment setting pop-up window receives a selection operation of the second position.

The container refers to a carrier configured to carry the bullet comment. In the present disclosure, the bullet comment may be displayed on the virtual screen, or may be displayed in a game interface. If the bullet comment is displayed on the virtual screen, the bullet comment setting pop-up window supports the display of the bullet comment on an upper or lower part of the virtual screen.

For example, the at least two bullet comments are displayed at a first position on the virtual screen before the display position is changed, and the at least two bullet comments located at the second position on the virtual screen are updated and displayed when the bullet comment setting pop-up window receives the selection operation of the second position. The first position and the second position are different.

For example, the at least two bullet comments are displayed at a first position in the game interface before the display position is changed, and the at least two bullet comments located at the second position in the game interface are updated and displayed when the bullet comment setting pop-up window receives the selection operation of the second position. The first position and the second position are different.

FIG. 9 further shows a top position selection control 904 and a bottom position selection control 905. When the top position selection control 904 receives a click/tap operation, at least two bullet comments are displayed at the top in a container. FIG. 9 shows a case in which the top position selection control 904 is selected, and the at least two bullet comments are displayed at the top in the container. In this case, the container is a virtual screen.

FIG. 10 shows a case in which the bottom position selection control 905 is selected, and the at least two bullet comments are displayed at the bottom in the container. In this case, the container is a game interface.

Operation 760: Switch at least two bullet comments from being displayed on a virtual screen to being displayed in a game interface when the bullet comment setting pop-up window receives a selection operation of the game interface; and update and display the at least two bullet comments in the game interface.

The at least two bullet comments are located on the virtual screen before a container is changed, and the at least two bullet comments in the game interface are updated and displayed when the bullet comment setting pop-up window receives the selection operation of the game interface.

FIG. 9 shows a container selection control 906. When the container selection control 906 is selected, the at least two bullet comments are switched from being displayed on the virtual screen to being displayed in the game interface.

For example, FIG. 10 shows a case that the container selection control 906 is selected, and the at least two bullet comments are displayed in the game interface.

In an embodiment, when the at least two bullet comments are displayed in the game interface, a bullet comment zoom-out icon is further displayed around the virtual screen, and when the bullet comment zoom-out icon receives a trigger operation, the at least two bullet comments are switched from being displayed in the game interface to being displayed on the virtual screen; and the at least two bullet comments on the virtual screen are updated and displayed.

FIG. 10 shows a bullet comment zoom-out icon 1001. When the bullet comment zoom-out icon 1001 receives a click/tap operation, at least two bullet comments are regressed to the virtual screen.

In an embodiment, when the virtual screen goes beyond a field of view of a current main control character, the at least two bullet comments are switched from being displayed in the game interface to being displayed on the virtual screen.

The current main control character is a virtual character controlled by an object logged in to the game client. The object controls the current main control character to move in the virtual environment, and when the virtual screen goes beyond the field of view of the current main control character, the at least two bullet comments are automatically regressed to the virtual screen.

In conclusion, the foregoing embodiments provide multiple bullet comment display modes, and provide a specific implementation for adding a video bullet comment function into the game client. The bullet comment function is closely combined with a game, allowing a player to enjoy a better bullet comment experience. For example, the player may personalize the color, font, font size, and display position of the bullet comment, to enhance a visual effect of the bullet comment during display and enhance the expression capability of the bullet comment content, thereby promoting cross-platform social interaction through the bullet comments.

Based on the exemplary embodiment shown in FIG. 2, after operation 260, at least one of the following operations S1 and S2 is further included.

Operation S1: For a first bullet comment of at least two bullet comments, display information of an object transmitting the first bullet comment on a gaming platform when the first bullet comment receives a trigger operation, the first bullet comment being transmitted by the object on the gaming platform; and

Display information of the object transmitting the first bullet comment on the gaming platform when the first bullet comment receives a click/tap operation of the object in a game client. In some embodiments, an identity (ID) of the object transmitting the first bullet comment is displayed.

In an embodiment, in a case that the first bullet comment is transmitted by a first creation object, a following button is displayed, the first creation object is a creation object whose number of followers is greater than a number threshold, and the creation object is an object creating a game level. When the following button receives a trigger operation, a following relationship between the current object logged in to the game client and the first creation object is established.

For example, in the present disclosure, the virtual environment accommodating the virtual screen is an environment in a user-defined game level, namely, the virtual environment is an environment created by the creation object. If the first bullet comment is transmitted by the first creation object, in addition to an ID of the first creation object, the following button is further displayed.

In some embodiments, the first creation object is a level creator whose number of followers is greater than 1000.

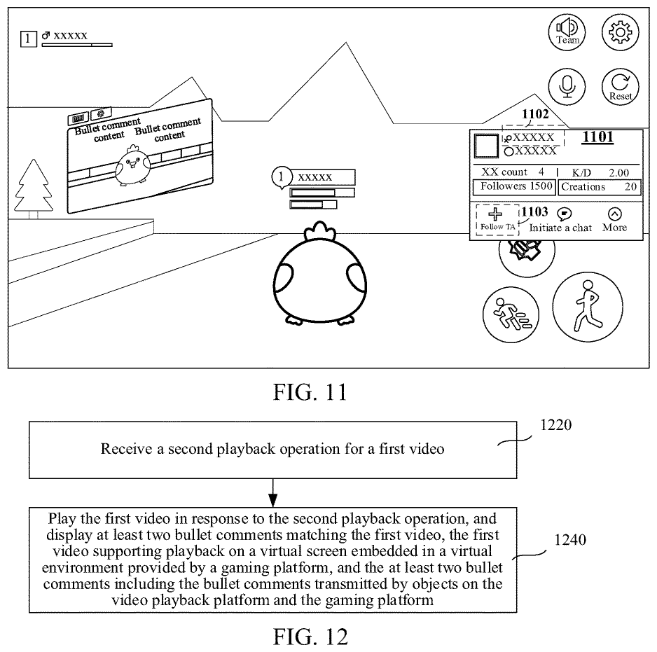

FIG. 11 is a schematic diagram of a game interface according to an exemplary embodiment of the present disclosure. FIG. 11 shows a player information pop-up window 1101. The player information pop-up window 1101 includes ID information 1102 of a first creation object and a following button 1103.

The above operation S1 provides a mode for interacting with the object on the gaming platform in the game client based on the bullet comment. If the bullet comment is from an influential player (a UGC creation object with a large number of followers), a following entrance is further provided. This not only helps improve popularity of the influential player and increase promotional channels for game levels, but also promotes player-to-player interaction within the game, thereby improving the gaming experience of the player.

Operation S2: For a second bullet comment of at least two bullet comments, display information of an object transmitting the second bullet comment on the video playback platform when the second bullet comment receives a trigger operation, the second bullet comment being transmitted by the object on the video playback platform.

When the second bullet comment receives a click/tap operation in the game client, the information of the object transmitting the second bullet comment on the video playback platform is displayed in the game interface. In some embodiments, ID information, account level information, and the like of the object transmitting the second bullet comment on the video playback platform are displayed. In some embodiments, a chat button is further displayed.

When the chat button receives a trigger operation, whether a video playback client is installed on a current terminal device is detected; and if the video playback client is installed, the video playback client is switched, and a private chat interface with the object is displayed in the video playback client. If the video playback client is not installed, prompt to jump to an application store to download the video playback client.

The above operation S2 provides a mode for interacting with the object of the video playback platform based on the bullet comment in the game client, and provides a cross-platform social interaction mode, thereby improving the gaming experience and social interaction fun of the player.

FIG. 12 is a flowchart of a video playback method according to an exemplary embodiment of the present disclosure. The method is applied to a video playback client. The video playback client is supported by a video playback platform. An example in which the method is performed by a computer device is used for description. The method includes the following operations:

Operation 1220: Receive a second playback operation for a first video.

The second playback operation is configured to control the video playback client to play the video. In some embodiments, the second playback operation is implemented as at least one of an operation triggered by a control, an operation triggered by a gesture, an operation triggered by a shortcut key, or an operation triggered by a user voice. This is not limited herein. In some embodiments, when the second playback operation is implemented as the operation triggered by the gesture, the second playback operation may be implemented as a long-press operation, a click/tap operation, a drag operation, a re-click/re-tap operation, a double-click/double-tap operation, or the like. This is not limited herein.

In some embodiments, the first video is video content selected by a user in the video playback client. For example, the video client displays a plurality of candidate videos and receives the second playback operation for selecting the first video from the plurality of candidate videos. Alternatively, the first video is video content searched by the user in the video playback client. For example, the video client displays a search box, and receives an input operation for the search box, to obtain a search keyword. The video client transmits the search keyword to a video server. The video server obtains at least one candidate video by matching based on the search keyword. The video client displays video information of the at least one candidate video, and receives the second playback operation for selecting the first video from the at least one candidate video.

Operation 1240: Play the first video when the second playback operation, and display at least two bullet comments matching the first video, the first video supporting playback on a virtual screen embedded in a virtual environment provided by a gaming platform, and the at least two bullet comments including the bullet comments transmitted by objects on a video playback platform and the gaming platform.

The video playback platform acquires bullet comment data for the first video from the gaming platform, and presents the bullet comment data in the video playback client. For example, after the game client receives a bullet comment transmitting operation of a user, the game client uploads the bullet comment data of the bullet comment transmitted by the user to the video server of the video playback platform. The video server correspondingly stores the bullet comment data and the first video, and transmits the bullet comment data to the video playback client when the video client plays the first video.

In some embodiments, the bullet comment from the gaming platform includes at least one of text, a picture, and an emoticon.

In an embodiment, when the current object plays the first video on the video playback client, the bullet comment transmitted by an object on the video playback platform is updated in real time. The at least two bullet comments include the bullet comment transmitted by the object on the video playback platform, and the terminal device acquires and displays, in real time, the bullet comments transmitted by the object on the video playback platform.

In a case that the current object re-opens the video playback interface, the updated bullet comment is pulled from the gaming platform, and the updated bullet comment is displayed. The at least two bullet comments include the bullet comment transmitted by the object on the gaming platform, and the bullet comment from the gaming platform is not updated in real time, but is updated only when the video playback interface is re-opened.

In an embodiment, for a first bullet comment of at least two bullet comments, the first bullet comment is displayed in a third bullet comment style, and the first bullet comment is transmitted by the object on the gaming platform.

For example, a game name and/or a game logo pattern is displayed, and content of the first bullet comment is displayed. The game name is a name of a game corresponding to the gaming platform.

For example, the first bullet comment having a game border is displayed, and the game border is configured to represent that the first bullet comment is from the gaming platform. The game border has characteristics of the game. For example, the game is an xxx party game, and a “party game” is displayed on the game border.

In an embodiment, for a first bullet comment of at least two bullet comments, when the first bullet comment receives a trigger operation, information of an object transmitting the first bullet comment on a gaming platform is displayed, and the first bullet comment is transmitted by the object on the gaming platform. For example, when the first bullet comment receives the trigger operation, the ID information of the object transmitting the first bullet comment on the gaming platform is displayed in a video playback interface.

In an embodiment, when the first bullet comment receives a trigger operation, and in a case that the first bullet comment is transmitted by a first creation object, a following button is displayed; the first creation object is a creation object whose number of followers on a gaming platform is greater than a number threshold, and the creation object is an object creating a game level; and when the following button receives a trigger operation, a game client supported by the gaming platform is switched to establish a following relationship between the object logged in to the game client and the first creation object.

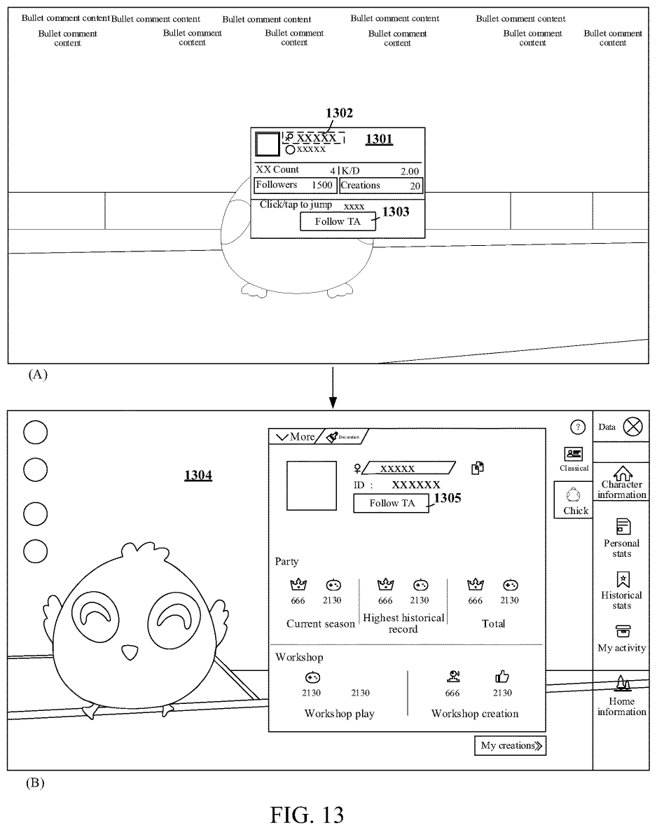

For example, when the first bullet comment is transmitted by the first creation object, the following button is further displayed in the video playback interface. Part (A) of FIG. 13 shows a video playback interface after a first bullet comment receives a trigger operation. The video playback interface displays an information pop-up window 1301. ID information 1302 of a first creation object and a following button 1303 are displayed on the information pop-up window 1301.

When the following button 1303 receives a trigger operation, a game client is switched. Part (B) of FIG. 13 shows an information interface 1304 of the first creation object. In the information interface 1304, an in-game following button (Follow TA button) 1305 is displayed, and when the in-game following button 1305 receives a trigger operation, a following relationship between the object logged in to the game client and the first creator object is established.

In conclusion, at least two bullet comments matching the first video are displayed on the video playback client, and the at least two bullet comments include the bullet comments transmitted by the objects on the video playback platform and the gaming platform. To be specific, the present disclosure provides a cross-platform social interaction solution implemented based on the bullet comments. The video playback interface may display the bullet comments transmitted by the object on the gaming platform, so that the subsequent cross-platform social interaction may be implemented based on the bullet comments.

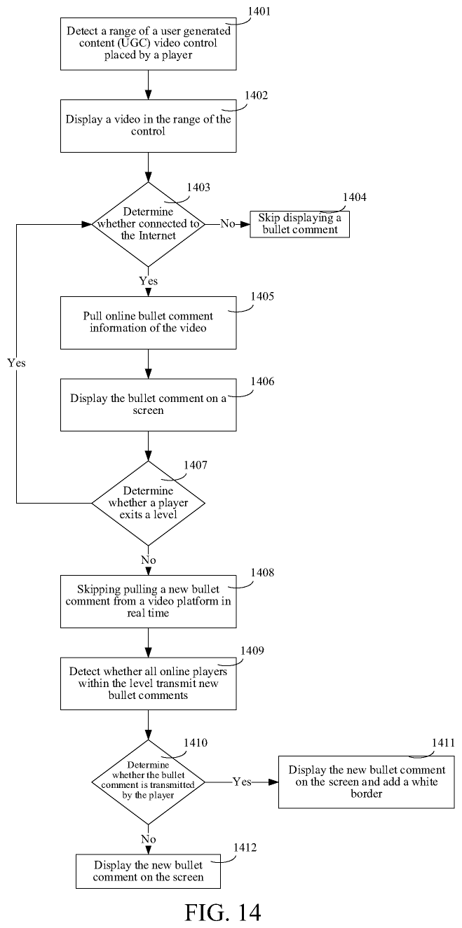

FIG. 14 is a flowchart of a picture display method according to an exemplary embodiment of the present disclosure. An example in which the method is performed by a computer device is used for description. The method includes:

Operation 1401: Detect a range of a user generated content (UGC) video control placed by a player.

When the player creates the UGC by a game client, the player may create, by placing the UGC video control, a virtual screen capable of playing video content. When the player places the UGC video control, the game client detects the range of the UGC video control placed by the player based on a placement position and a size of the UGC video control, and displays a video in the control.

Operation 1402: Display the video in the range of the control.

The video is a specific video set when the player creates the UGC video control. In some embodiments, a video cover of the video is displayed within the range of the control; or the video is played within the range of the control; or a video title of the video is displayed within range of the control; or a video link of the video is displayed within the range of the control.

Operation 1403: Determine whether connected to the Internet.

After a level is posted, the player may create a game battle corresponding to the level. Within the game battle of the level, in a case that the level is connected to the Internet, based on a video platform and a specific video selected by a player, online bullet comment information of the video is synchronously pulled. In a case that the level is not connected to the Internet, the bullet comment is not displayed.

For example, the game client detects whether a computer device is in an online state when the player creates the game battle of the level, to determine whether to be connected to the Internet. Alternatively, the game client determines whether the player creates an Internet-connected level or a local level (i.e., a level that is not connected to the Internet) based on settings of the game battle when the player creates the game battle of the level, to determine whether the level is connected to the Internet.

Operation 1404: Skip displaying the bullet comment.

The game client displays the virtual screen within the level. The video selected by the player is played on the virtual screen. In a non-networked state, only content of the video is displayed on the virtual screen during video playback.

Operation 1405: Pull online bullet comment information of the video.

The game client displays the virtual screen within the level. The specific video selected by the player is played on the virtual screen. In a networked state, during the video playback, the online bullet comment information of the video is acquired from a video server corresponding to the video platform.

Operation 1406: Display the bullet comment on a screen.

In an embodiment, the online bullet comment information is transmitted to the game client in an information stream form, and the game client displays the bullet comment information in the information stream form on the screen.

Operation 1407: Determine whether the player exits the level.

The game client detects an operation of the player in real time, and determines whether the player exits a game battle corresponding to a current level. If the player does not exit the level, operation 1408 is performed. If the player exits the level, operation 1403 is performed again.

Operation 1408: Skipping pulling a new bullet comment from the video platform in real time.

If the player does not exit the level, the updated bullet comment information of the video platform is no longer pulled in real time, and only the bullet comment information transmitted by the online player within the UGC level is updated in real time.

Operation 1409: Detect whether all online players within the level transmit new bullet comments.

Whether all online players within the level transmit the new bullet comments is detected, and if all online players within the level transmit the new bullet comments, the new bullet comments are synchronized to a video control in the game.

Operation 1410: Determine whether the bullet comment is transmitted by the player.

Whether the player within the level transmits the new bullet comment is detected, and if the player within the level transmits the new bullet comment, the new bullet comment is synchronized to the video control in the game, and the bullet comment is added with a special white border. If the player within the level does not transmit the new bullet comment, the bullet comment transmitted by another player is displayed on the screen.

Operation 1411: Display the new bullet comment on the screen and add a white border.

When the bullet comment displayed on the screen is the new bullet comment transmitted by the player, the bullet comment is added with the white border during display of the bullet comment to perform highlight prompt to indicate that the bullet comment is transmitted by the player.

Operation 1412: Display the new bullet comment on the screen.

When an online player within the level transmits a new bullet comment, the new bullet comment is synchronously displayed on the virtual screen corresponding to the video control.

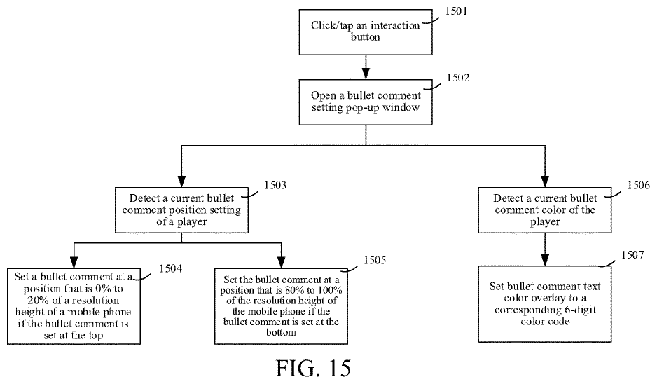

FIG. 15 is a flowchart of a picture display method according to an exemplary embodiment of the present disclosure. An example in which the method is performed by a computer device is used for description. The method includes:

Operation 1501: Click/tap an interaction button.

In the level, when the player watches a video by using a video control, the game client further displays bullet comments from a video playback platform and a gaming platform, and the player may further set a bullet comment style for a displayed or to-be-posted bullet comment using the interaction button.

For example, the game client displays the interaction button around the virtual screen corresponding to the video control, the player clicks/taps the interaction button, and the game client detects a click/tap signal received by the interaction button, and responds to the click/tap signal in a case that the click/tap signal is valid.

Operation 1502: Open a bullet comment setting pop-up window.

The game client responds to the click/tap signal for the interaction button, and opens the bullet comment setting pop-up window. The bullet comment setting pop-up window covers a part of a screen area of a game interface and provides a setting option for the bullet comment to the player.

In some embodiments, the bullet comment setting pop-up window may be a setting pop-up window for a single bullet comment, or may be a setting pop-up window for a plurality of bullet comments.

Operation 1503: Detect a current bullet comment position setting of the player.

The bullet comment setting pop-up window provides an option of a position partition of a bullet comment position, and a mobile phone detects the position partition set by the player. In an example, the position partition includes a top and a bottom.

Operation 1504: Set the bullet comment at a position that is 0% to 20% of the resolution height of the mobile phone if the bullet comment is set at the top.

If the player sets the bullet comment at the top, the bullet comment is set at the position that is 0% to 20% of the resolution height of the mobile phone, namely, the position that is 0% to 20% of the resolution height of the mobile phone belongs to the top partition.

For example, the game client displays the bullet comment at the top by adjusting a rendering logic of the mobile phone for the bullet comment.

Operation 1505: Set the bullet comment at a position that is 80% to 100% of the resolution height of the mobile phone if the bullet comment is set at the bottom.

If the player sets the bullet comment at the bottom, the bullet comment is set at the position that is 80% to 100% of the resolution height of the mobile phone, namely, the position that is 80% to 100% of the resolution height of the mobile phone belongs to the bottom partition.

For example, the game client displays the bullet comment at the bottom by adjusting a rendering logic of the mobile phone for the bullet comment.

Operation 1506: Detect a current bullet comment color of the player.

For example, the bullet comment setting pop-up window further provides a selection option for the color of the bullet comment, and the player may select a favorite color to display the bullet comment.

The game client identifies the color selected by the player, and converts the color into a corresponding color 6-bit code (for example, #FFFFFF indicates white) based on the color selected by the player, to set the color of the bullet comment.

Operation 1507: Set bullet comment text color overlay to a corresponding 6-bit color code.

For example, the game client detects a color selector state in the game interface, and sets the color selector state to a corresponding 6-bit color code, so that the color of the bullet comment displayed in the game interface is the color selected by the player.

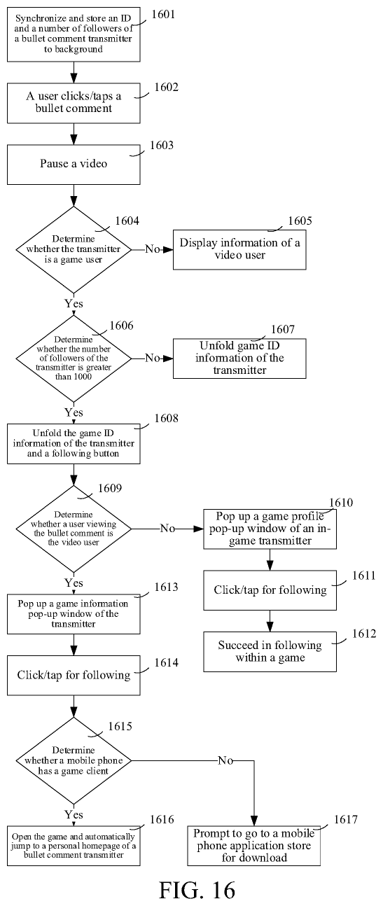

FIG. 16 is a flowchart of a picture display method according to an exemplary embodiment of the present disclosure. An example in which the method is performed by a computer device is used for description. The method includes:

Operation 1601: Synchronize and store an ID and a number of followers of a bullet comment transmitter to background.

For example, when the player transmits the bullet comment, the game client synchronizes the ID and number of followers of the bullet comment transmitter and the bullet comment to the background (such as a game server and/or a video server), and the background stores the foregoing information.

Operation 1602: A user clicks/taps a bullet comment.

During video playback, the user may touch the screen to tap the bullet comment of interest, thereby facilitating subsequent social interaction process through the bullet comment. For example, a tap signal received by the screen is detected, a tap event is generated based on the tap signal, and the tap event is subsequently processed.

Operation 1603: Pause the video.

For example, the video playback is paused when detecting the tap event. In some embodiments, when the video is paused, updating display and/or scrolling display of the bullet comment is paused, namely, the bullet comment matching the video enters a display pause state.

Operation 1604: Determine whether the transmitter is a game user; and perform operation 1605 if the transmitter is not the game user; and perform operation 1606 if the transmitter is the game user.

Operation 1605: Display information of a video user.

For example, when the transmitter of the bullet comment is not the game user, the transmitter of the bullet comment is the video user from the video playback platform, and when relevant information of the bullet comment is displayed, at least one of account information such as an account name, an account ID, and an account profile photo of the video user is displayed.

Operation 1606: Determine whether a number of followers of the transmitter is greater than 1000.

For example, when the transmitter of the bullet comment is the game user, if the number of followers of the transmitter is not greater than 1000, operation 1607 is performed; and if the number of followers of the transmitter is greater than 1000, operation 1608 is performed.

Operation 1607: Unfold game ID information of the transmitter.

For example, when the number of followers of the transmitter is not greater than 1000, the game ID information of the transmitter is directly displayed, to display related information of the game player transmitting the bullet comment to the user.

Operation 1608: Unfold the game ID information of the transmitter and a following button.

For example, when the number of followers of the transmitter is greater than 1000, the transmitter is a UGC creator having a follower basis, and the user may follow the transmitter using the provided following button, thereby implementing a social interaction process with the transmitter.

Operation 1609: Determine whether a user viewing the bullet comment is a video user; and perform operation 1610 if the user viewing the bullet comment is not the video user; and perform operation 1613 if the user viewing the bullet comment is the video user.

Operation 1610: Pop up a game profile pop-up window of an in-game transmitter.

When the user viewing the bullet comment is the game user, the game profile pop-up window of the in-game transmitter corresponding to the bullet comment is directly popped up. The game profile pop-up window includes a following button, and the user viewing the bullet comment may use this following button to engage in in-game social interactions on the same platform.

Operation 1611: Click/tap for following.

For example, the tap signal received by the screen is detected, the tap event corresponding to the tap signal is determined based on a range of the tap signal on the screen, and when the range of the tap signal is a control range corresponding to the following button, it is determined that the tap event for tapping the button is received.

Operation 1612: Succeed in following within the game.

In a case that the user viewing the bullet comment is the game user, a player profile of the transmitter is opened in the game, and it is prompted that the transmitter is already followed.

Operation 1613: Pop up a game information pop-up window of the transmitter.

When the user viewing the bullet comment is the video user, the game information pop-up window of the transmitter is popped up on the video playback client. The game information pop-up window includes a following button. The user viewing the bullet comment may implement cross-platform social interaction between the video playback platform and the gaming platform using the following button.

Operation 1614: Click/tap for following.

For example, the tap signal received by the screen is detected, the tap event corresponding to the tap signal is determined based on a range of the tap signal on the screen, and when the range of the tap signal is a control range corresponding to the following button, it is determined that the tap event for tapping the button is received.

Operation 1615: Determine whether the mobile phone has a game client.

When the user viewing the bullet comment is the video user, the game profile information of the user is opened, and the following button appears. In a case that the video user taps for following, whether the mobile phone has the game client is determined. If the game client is installed on the mobile phone, operation 1616 is performed. If the game client is not installed on the mobile phone, operation 1617 is performed.

Operation 1616: Open the game, and automatically jump to a personal home page of a bullet comment transmitter.

In a case that the game client is installed on the mobile phone, the game client is automatically opened, and the personal home page corresponding to the bullet comment transmitter is displayed. For example, the video playback client pulls up a game interface of the game client by using an application programming interface (API) provided by the game client, and indicates account information of the bullet comment transmitter using the API, and the game client displays the personal home page of the bullet comment transmitter based on the account information.

Operation 1617: Prompt to go to a mobile phone application store for download.

In a case that the game client is not installed on the mobile phone, the video client displays prompt information, and the prompt information prompts the user to go to a mobile phone application store for download.

In some embodiments, the prompt information further includes a jump link of the mobile phone application store, and the user jumps to the mobile phone application store using the jump link, and displays a download interface corresponding to the game client.

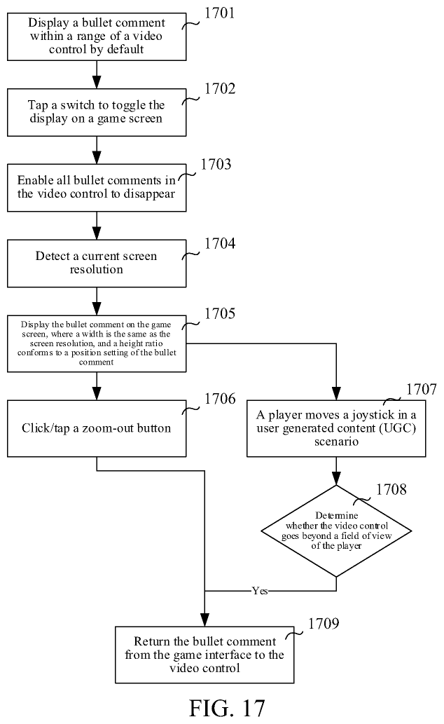

FIG. 17 is a flowchart of a picture display method according to an exemplary embodiment of the present disclosure. An example in which the method is performed by a computer device is used for description. The method includes:

Operation 1701: Display a bullet comment within a range of a video control by default.

When a video is played on a game client by using the video control, a bullet comment matching the video is displayed in a range of the video control by default, where the bullet comment includes the bullet comment transmitted by a user of the gaming platform and the bullet comment transmitted by the user of the video playback platform.

In some embodiments, the bullet comment is displayed by default within the range of the video control in a scrolling display mode.

Operation 1702: Tap a switch to toggle the display on a game screen.

For example, the game client displays a switch control for switching the display of the bullet comment in the game interface. When the switch control receives a trigger operation, the bullet comment is switched to be displayed on the game screen. The game screen is a full screen area where the game client displays the game interface, namely, the bullet comments are directly overlaid and displayed in the game interface. To be specific, when the player taps the switch control to switch the display on the game screen, all bullet comments in the video control disappear, and are displayed on the game screen instead. Only the video is played in the video control.

Operation 1703: Enable all bullet comments in the video control to disappear.

Operation 1704: Detect a current screen resolution.

Before the bullet comment is displayed on the game screen, the game client needs to first detect a screen resolution of a current device. The screen resolution refers to a width and height of the screen in terms of pixels. Different devices may have different resolutions. By detecting the screen resolution, the game client may ensure that the bullet comments can be displayed in an optimal mode on different devices. The game client invokes an API of an operating system of the device to acquire a width pixel value and a height pixel value of the current screen, and stores the data into a memory, so that subsequent bullet comment rendering can be precisely laid and adjusted based on the data.

Operation 1705: Display the bullet comment on the game screen, where the width is the same as the screen resolution, and a height ratio conforms to a position setting of the bullet comment.

After the current screen resolution is detected, the game client displays the bullet comment on the game screen based on a bullet comment position previously set by a bullet comment transmitter or a user of the current device. The current screen resolution is detected, the bullet comment position currently set by the player is detected, and the bullet comment is displayed on the game screen, where the width is the same as the screen resolution, and a height position ratio conforms to the position setting of the bullet comment. To be specific, the width of the bullet comment is completely the same as the width of the screen, thereby ensuring that the bullet comment can cover an entire width range of the screen. At the same time, the height position of the bullet comment is adjusted based on settings of the bullet comment transmitter or the player of the current device. For example, if the bullet comment transmitter sets the bullet comment to be displayed at the top of the screen when transmitting the bullet comment, the height position of the bullet comment is close to a top area of the screen. If the bullet comment is displayed at the bottom, the height position of the bullet comment is close to a bottom area of the screen. By using the flexible layout mode, the player may freely adjust a display position of the bullet comment based on a preference and an operation habit of the player, thereby obtaining better watching experience.

Operation 1706: Click/tap a zoom-out button.

The game client displays a zoom-out button for the bullet comment in the game interface, and the player clicks/taps the zoom-out button to return to the default setting. To be specific, if the player wants to restore to a default display state after the bullet comment is displayed on the game screen, the player may click/tap the zoom-out button in the interface. When the player clicks/taps the zoom-out button, the game client receives an operation signal, and displays the bullet comment in the video control when the operation signal is received.

Operation 1707: The player moves a joystick in a UGC scenario.

If the zoom-out button is not clicked/tapped, but when the player moves the joystick in the UGC scenario, if the video control goes beyond a field of view of the player, the bullet comment may be automatically returned from the game interface to the video control, namely, the currently displayed game interface does not include the video played by the video control and the matched bullet comment.

Operation 1708: Determine whether the video control goes beyond the field of view of the player.

For example, the game client calculates whether the video control is within the field of view of the player based on a viewing angle of a virtual character controlled by the player, a position of the character, and a position and a size of the video control. If the video control goes beyond the field of view of the player, an automatic adjustment mechanism of the bullet comment is triggered, and the bullet comment is restored to the default display.

Operation 1709: Return the bullet comment from the game interface to the video control.

For example, when the game client determines that the video control goes beyond the field of view of the player, the bullet comment is automatically removed from the game screen and returned to the video control. When the bullet comment is returned to the video control, the display position, size, and style of the bullet comment are all restored to default settings, and kept the same as the layout of the video control.

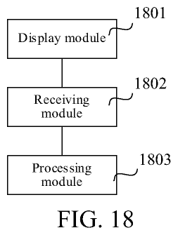

FIG. 18 is a structural block diagram of a picture display apparatus according to an exemplary embodiment of the present disclosure. A game client is installed on the apparatus, and the apparatus includes:
a display module 1801, configured to display a virtual screen embedded in a virtual environment; and
receiving module 1802, configured to receive a first playback operation for a first video, the first video being a video from a video playback platform,
where the display module 1801 is further configured to play the first video on the virtual screen when the first playback operation is received; and
the display module 1801 is further configured to display at least two bullet comments matching the first video, the at least two bullet comments including the bullet comments transmitted by objects on the video playback platform and a gaming platform.

In an exemplary embodiment, the display module 1801 is further configured to display, for a first bullet comment of at least two bullet comments, the first bullet comment in a first bullet comment style, the first bullet comment being transmitted by an object on the gaming platform; and
display, for a second bullet comment of at least two bullet comments, the second bullet comment in a second bullet comment style, the second bullet comment being transmitted by an object on a video playback platform, where
the first bullet comment style and the second bullet comment style are distinctive bullet comment styles having at least one of a bullet comment special effect, a pattern, a border, a font, a color, a font size, and source information.

In an exemplary embodiment, the virtual environment includes a first seat located around a virtual screen; and the display module 1801 is further configured to display first seat information and content of the first bullet comment in a case that the first bullet comment is from a first object, the first object being an object controlling the virtual character to be located at the first seat on the gaming platform, and the first seat information being related information of the first seat.

In an exemplary embodiment, the display module 1801 is further configured to display the first bullet comment having a first style border, where the first style border is associated with a building style of the virtual environment.

In an exemplary embodiment, the display module 1801 is further configured to display the first bullet comment having a first dynamic special effect when a number of virtual characters accommodated in the virtual environment is within a first number range, the first dynamic special effect being a dynamic special effect corresponding to the first number range.

In an exemplary embodiment, the virtual environment is an environment customized by the associated object; and the display module 1801 is further configured to display the first bullet comment having a first relationship border in a case that the first bullet comment is from a second object, where the second object is an object having a first intimate relationship with the associated object on the gaming platform, and the first relationship border corresponds to the first intimate relationship.

In an exemplary embodiment, the display module 1801 is further configured to display level information of a third object on the video playback platform and content of the second bullet comment in a case that the second bullet comment is from the third object on the video playback platform.

In an exemplary embodiment, the display module 1801 is further configured to display a bullet comment editing icon; display a bullet comment editing interface when the bullet comment editing icon receives a trigger operation; and display a third bullet comment having an addition mark when the bullet comment editing interface receives a bullet comment editing operation and a bullet comment transmitting operation, the addition mark indicating that the third bullet comment is a newly transmitted bullet comment.

In an exemplary embodiment, the display module 1801 is further configured to display a bullet comment setting icon; display a bullet comment setting pop-up window when the bullet comment setting icon receives a trigger operation; and update and display at least one bullet comment style of the at least two bullet comments when the bullet comment setting pop-up window receives at least one setting operation.

In an exemplary embodiment, the at least two bullet comments have a first color; and the display module 1801 is further configured to update and display at least two bullet comments having a second color when the bullet comment setting pop-up window receives a selection operation of the second color.

In an exemplary embodiment, the at least two bullet comments have a first font size; and the display module 1801 is further configured to update and display at least two bullet comments having a second font size when the bullet comment setting pop-up window receives a selection operation of the second font size.

In an exemplary embodiment, the at least two bullet comments are located at a first position in a container; and the display module 1801 is further configured to update and display at least two bullet comments located at a second position in the container when the bullet comment setting pop-up window receives a selection operation of the second position.

In an exemplary embodiment, the at least two bullet comments are located in a virtual screen; and the display module 1801 is further configured to switch at least two bullet comments from being displayed on the virtual screen to being displayed in a game interface when the bullet comment setting pop-up window receives a selection operation of the game interface; and update and display the at least two bullet comments in the game interface.

In an exemplary embodiment, the display module 1801 is further configured to display a bullet comment zoom-out icon around the virtual screen; switch at least two bullet comments from being displayed in the game interface to being displayed on the virtual screen when the bullet comment zoom-out icon receives a trigger operation; and update and display the at least two bullet comments on the virtual screen.

In an exemplary embodiment, the display module 1801 is further configured to switch at least two bullet comments from being displayed in the game interface to being displayed on the virtual screen when the virtual screen goes beyond a field of view of a current main control character.

In an exemplary embodiment, the display module 1801 is further configured to display, for a first bullet comment of at least two bullet comments, information of an object transmitting the first bullet comment on the gaming platform when the first bullet comment receives a trigger operation, the first bullet comment being transmitted by the object on the gaming platform.

In an exemplary embodiment, the display module 1801 is further configured to display, for a second bullet comment of at least two bullet comments, information of an object transmitting the second bullet comment on the video playback platform when the second bullet comment receives a trigger operation, the second bullet comment being transmitted by the object on the video playback platform.

In an exemplary embodiment, the display module 1801 is further configured to display a following button in a case that the first bullet comment is transmitted by a first creation object, the first creation object being a creation object whose number of followers is greater than a number threshold, and the creation object being an object creating a game level.

The picture display apparatus further includes a processing module 1803. The processing module 1803 is configured to establish a following relationship between a current object logged in to the game client and the first creation object when the following button receives a trigger operation.

In an exemplary embodiment, the display module 1801 is further configured to update, in real time, the bullet comment transmitted by an object on the gaming platform when the current object logged in to the game client is in the virtual environment; and
pull an updated bullet comment from the video playback platform and display the updated bullet comment in a case that the current object re-enters the virtual environment.

In conclusion, the first video is played on the virtual screen, the at least two bullet comments matching the first video are displayed, and the at least two bullet comments include the bullet comments transmitted by the objects on the video playback platform and the gaming platform. To be specific, the present disclosure provides a cross-platform social interaction solution implemented based on the bullet comments. The game interface may display the bullet comments transmitted by the object on the video playback platform, so that the subsequent cross-platform social interaction may be implemented based on the bullet comments.

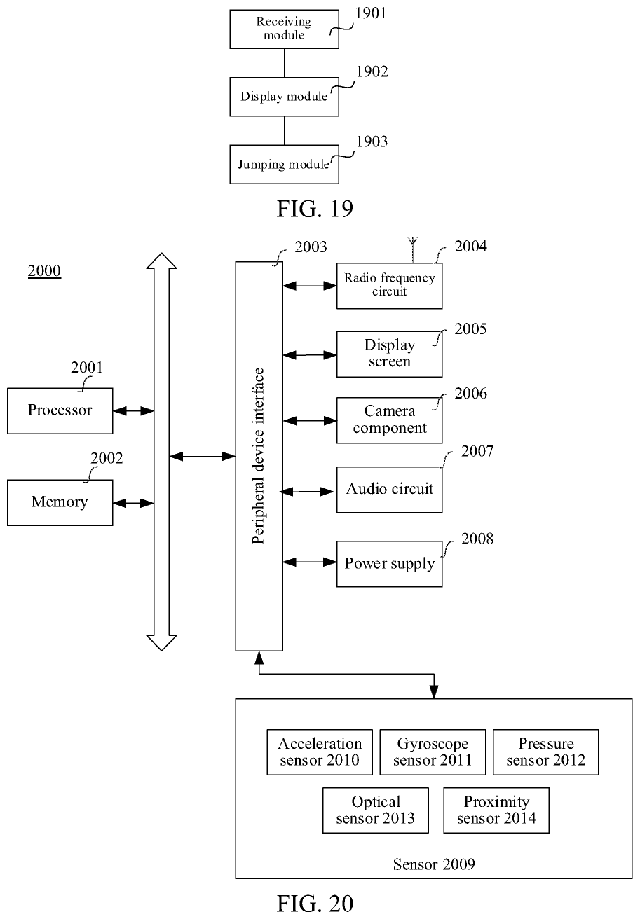

FIG. 19 is a structural block diagram of a video playback apparatus according to an exemplary embodiment of the present disclosure. A video playback client is installed on the apparatus, the video playback client is supported by a video playback platform, and the apparatus includes:
a receiving module 1901, configured to receive a second playback operation for a first video; and
a display module 1902, configured to play the first video when the second playback operation, and display at least two bullet comments matching the first video, the first video supporting playback on a virtual screen embedded in a virtual environment provided by a gaming platform, and the at least two bullet comments including the bullet comments transmitted by an object on a video playback platform and the gaming platform.

In an exemplary embodiment, the display module 1902 is further configured to display, for a first bullet comment of the at least two bullet comments, information of an object transmitting the first bullet comment on the gaming platform when the first bullet comment receives a trigger operation, the first bullet comment being transmitted by the object on the gaming platform.

In an exemplary embodiment, the display module 1902 is further configured to display a following button when the first bullet comment receives a trigger operation and in a case that the first bullet comment is transmitted by a first creation object, the first creation object being a creation object whose number of followers on a gaming platform is greater than a number threshold, and the creation object being an object creating a game level.

The video playback apparatus further includes a jumping module 1903. The jumping module 1903 is configured to, when the following button receives a trigger operation, jump to a game client supported by the gaming platform, to establish a following relationship between the object logged in to the game client and the first creation object.

In conclusion, at least two bullet comments matching the first video are displayed on the video playback client, and the at least two bullet comments include the bullet comments transmitted by the objects on the video playback platform and the gaming platform. To be specific, the present disclosure provides a cross-platform social interaction solution implemented based on the bullet comments. The video playback interface may display the bullet comments transmitted by the object on the gaming platform, so that the subsequent cross-platform social interaction may be implemented based on the bullet comments.

FIG. 20 is a structural block diagram of a computer device 2000 according to an exemplary embodiment of the present disclosure. The computer device 2000 may be a portable mobile terminal such as a smart-phone, a tablet computer, a moving picture experts group audio layer III (MP3) player, or a moving picture experts group audio layer IV (MP4) player. The computer device 2000 may be further referred to as another name such as user equipment, portable terminal device, or head-mounted computer device.

Generally, the computer device 2000 includes a processor 2001 and a memory 2002.

The processor 2001 may include one or more processing cores, such as, a 4-core processor or an 8-core processor. In some embodiments, the processor 2001 may be integrated with a graphics processing unit (GPU). The GPU is configured to render and draw content that needs to be displayed on a display screen.

The memory 2002 may include one or more computer-readable storage media. The computer-readable storage medium may be tangible and non-transient. In some embodiments, a non-transient computer-readable storage medium in the memory 2002 is configured to store at least one instruction, and the at least one instruction is configured to be executed by the processor 2001 to implement the picture display method and/or the video playback method provided in the embodiments of the present disclosure.

In some embodiments, the computer device 2000 further includes: a peripheral device interface 2003 and at least one peripheral device. The peripheral device includes at least one of a radio frequency (RF) circuit 2004, a display screen 2005, a camera component 2006, an audio circuit 2007, and a power supply 2008.

The peripheral device interface 2003 may be configured to connect the at least one peripheral device related to input/output (I/O) to the processor 2001 and the memory 2002. The radio frequency circuit 2004 is configured to receive and transmit a radio frequency (RF) signal, further referred to as an electromagnetic signal. The RF circuit 2004 communicates with a communication network and other communication devices through the electromagnetic signal. The display screen 2005 is configured to display a user interface (UI). The UI may include a graph, text, an icon, a video, and any combination thereof. The camera component 2006 is configured to collect images or videos. The audio circuit 2007 is configured to provide an audio interface between a user and the computer device 2000. The power supply 2008 is configured to supply power to the components in the computer device 2000.

In some embodiments, the computer device 2000 further includes one or more sensors 2009. The one or more sensors 2009 include, but are not limited to an acceleration sensor 2010, a gyroscope sensor 2011, a pressure sensor 2012, an optical sensor 2013, and a proximity sensor 2014.

A person skilled in the art may understand that the structure shown in FIG. 20 constitutes no limitation on the computer device 2000, and the computer device may include more or fewer components than those shown in the figure, or some components may be combined, or a different component deployment may be used.

An embodiment of the present disclosure further provides a computer device. The computer device includes a processor and a memory, the memory has at least one instruction, at least one segment of program, and a code set or an instruction set stored therein. The at least one instruction, the at least one segment of program, and the code set or the instruction set are loaded and executed by the processor to implement the picture display method provided in the foregoing method embodiments.

An embodiment of the present disclosure further provides a computer-readable storage medium, the computer-readable storage medium having a computer program stored therein, and the computer program being configured to be executed by a computer device to implement the foregoing picture display method and/or the video playback method.

For example, the computer-readable storage medium may include: a read-only memory (ROM), a random-access memory (RAM), a solid state drive (SSD), an optical disc, or the like. The RAM may include a resistance random access memory (ReRAM) and a dynamic random access memory (DRAM). The present disclosure further provides a computer-readable storage medium, the storage medium having at least one instruction, at least one segment of program, a code set or an instruction set stored therein, and the at least one instruction, the at least one segment of program, the code set or the instruction set being loaded and executed by a processor to implement the picture display method and/or the video playback method provided in the foregoing method embodiments.

The present disclosure provides a computer program product or a computer program. The computer program product or computer program includes computer instructions. The computer instructions are stored in a computer-readable storage medium. A processor of a computer device reads the computer instructions from the computer-readable storage medium, and the processor executes the computer instructions to cause the computer device to implement the picture display method and/or the video playback method in the foregoing method embodiments.

The sequence numbers of the foregoing embodiments of the present disclosure are merely for description purposes but do not imply the preference among the embodiments.

A person of ordinary skill in the art may understand that all or some of the operations of the foregoing embodiments may be implemented by hardware, or may be implemented by a program instructing relevant hardware. The program may be stored in a computer-readable storage medium. The storage medium may be a read-only memory, a magnetic disk, an optical disc, or the like.

What is claimed is:

1. A picture display method, performed by a computer device and applied to a game client, the method comprising:
displaying a virtual screen embedded in a virtual environment;
receiving a first playback operation for a first video, the first video being a video from a video playback platform;
playing the first video on the virtual screen when the first playback operation is received; and
displaying at least two bullet comments matching the first video, the at least two bullet comments comprising bullet comments transmitted by objects on the video playback platform and a gaming platform.

2. The method according to claim 1, wherein the displaying at least two bullet comments matching the first video comprises:
displaying a first bullet comment in a first bullet comment style for the first bullet comment of the at least two bullet comments, the first bullet comment being transmitted by a first object on the gaming platform; and
displaying a second bullet comment in a second bullet comment style for the second bullet comment of the at least two bullet comments, the second bullet comment being transmitted by a second object on the video playback platform,
wherein the first bullet comment style is different from the second bullet comment style, each of the first bullet comment style and the second bullet comment style having at least one of a bullet comment special effect, a pattern, a border, a font, a color, a font size, and source information.

3. The method according to claim 2, wherein the virtual environment comprises a first seat located around the virtual screen; and
the displaying a first bullet comment in a first bullet comment style comprises:
displaying first seat information and content of the first bullet comment in a case that the first bullet comment is from the first object, the first object being an object controlling a virtual character to be located at the first seat on the gaming platform, and the first seat information being related information of the first seat.

4. The method according to claim 3, wherein the displaying a first bullet comment in a first bullet comment style comprises:
displaying the first bullet comment having a first style border, the first style border being associated with a building style of the virtual environment.

5. The method according to claim 4, wherein the displaying a first bullet comment in a first bullet comment style comprises:
displaying the first bullet comment having a first dynamic special effect when a number of virtual characters accommodated in the virtual environment is within a first number range, the first dynamic special effect being a dynamic special effect corresponding to the first number range.

6. The method according to claim 5, wherein the virtual environment is an environment customized by an associated object; and
the displaying a first bullet comment in a first bullet comment style comprises:
displaying the first bullet comment having a first relationship border in a case the first bullet comment is from the second object, the second object being an object on the gaming platform having a first intimate relationship with the associated object, and the first relationship border being a border corresponding to the first intimate relationship.

7. The method according to claim 6, wherein the displaying a second bullet comment in a second bullet comment style comprises:
displaying level information of a third object on the video playback platform and content of the second bullet comment in a case that the second bullet comment is from the third object on the video playback platform.

8. The method according to claim 1, the method further comprising:
displaying a bullet comment editing icon;
displaying a bullet comment editing interface when the bullet comment editing icon receives a trigger operation;
displaying a third bullet comment with an addition mark when the bullet comment editing interface receives a bullet comment editing operation and a bullet comment transmitting operation, the addition mark indicating that the third bullet comment is a newly transmitted bullet comment.

9. The method according to claim 1, the method further comprising:
displaying a bullet comment setting icon;
displaying a bullet comment setting pop-up window when the bullet comment setting icon receives a trigger operation; and
updating and displaying at least one bullet comment style of the at least two bullet comments when the bullet comment setting pop-up window receives at least one setting operation.

10. The method according to claim 9, wherein the at least two bullet comments have a first color; and the updating and displaying at least one bullet comment style of the at least two bullet comments when the bullet comment setting pop-up window receives at least one setting operation comprises:
updating and displaying the at least two bullet comments having a second color when the bullet comment setting pop-up window receives a selection operation of the second color.

11. The method according to claim 10, wherein the at least two bullet comments have a first font size; and the updating and displaying at least one bullet comment style of the at least two bullet comments when the bullet comment setting pop-up window receives at least one setting operation comprises:
displaying the bullet comment setting pop-up window when the bullet comment setting icon receives a trigger operation; and
updating and displaying the at least two bullet comments having a second font size when the bullet comment setting pop-up window receives a selection operation of the second font size.

12. The method according to claim 11, wherein the at least two bullet comments are located at a first position in a container; and the updating and displaying at least one bullet comment style of the at least two bullet comments when the bullet comment setting pop-up window receives at least one setting operation comprises:
updating and displaying the at least two bullet comments located at a second position in the container when the bullet comment setting pop-up window receives a selection operation of the second position.

13. The method according to claim 12, wherein the at least two bullet comments are located on the virtual screen; and the updating and displaying at least one bullet comment style of the at least two bullet comments when the bullet comment setting pop-up window receives at least one setting operation comprises:
switching the at least two bullet comments from being displayed on the virtual screen to being displayed in a game interface when the bullet comment setting pop-up window receives a selection operation of the game interface; and
updating and displaying the at least two bullet comments in the game interface.

14. The method according to claim 13, the method further comprising:
displaying a bullet comment zoom-out icon;
switching the at least two bullet comments from being displayed in the game interface to being displayed on the virtual screen when the bullet comment zoom-out icon receives a trigger operation; and
updating and displaying the at least two bullet comments on the virtual screen.

15. The method according to claim 14, the method further comprising:
switching the at least two bullet comments from being displayed in the game interface to being displayed on the virtual screen when the virtual screen goes beyond a field of view of a current main control character.

16. The method according to claim 15, the method further comprising one of the following:
displaying information of a third object transmitting a first bullet comment on the gaming platform when the first bullet comment receives a trigger operation for the first bullet comment of the at least two bullet comments, the first bullet comment being transmitted by the third object on the gaming platform; and
displaying information of a fourth object transmitting a second bullet comment on the video playback platform when the second bullet comment receives a trigger operation for the second bullet comment of the at least two bullet comments, the second bullet comment being transmitted by a fourth object on the video playback platform.

17. The method according to claim 16, the method further comprising:
displaying a following button in a case that the first bullet comment is transmitted by a first creation object, the first creation object being a creation object whose number of followers is greater than a number threshold, and the creation object being a fifth object creating a game level; and
establishing a following relationship between a current object logged in to the game client and the first creation object when the following button receives a trigger operation.

18. The method according to claim 17, the method further comprising:
updating, in real time, a bullet comment transmitted by a sixth object on the gaming platform when the current object logged in to the game client is in the virtual environment; and
pulling an updated bullet comment from the video playback platform in a case that the current object re-enters the virtual environment, and displaying the updated bullet comment.

19. A picture display apparatus, a game client being installed on the picture display apparatus, and the apparatus comprising:
at least one memory configured to store program code; and
at least one processor configured to read the program code and operate as instructed by the program code, the program code comprising:
a first display code configured to cause the at least one of the at least one processor to display a virtual screen embedded in a virtual environment; and
a receiving code configured to cause the at least one of the at least one processor to receive a first playback operation for a first video, the first video being a video from a video playback platform,
a playing code configured to cause the at least one of the at least one processor to play the first video on the virtual screen when the first playback operation is received; and
a second display code configured to cause the at least one of the at least one processor to display at least two bullet comments matching the first video, and the at least two bullet comments comprising bullet comments transmitted by objects on the video playback platform and a gaming platform.

20. A non-transitory computer-readable storage medium, storing computer code, the computer code which, when executed by at least one processor, causes the at least one processor to at least:
display a virtual screen embedded in a virtual environment;
receive a first playback operation for a first video, the first video being a video from a video playback platform;
play the first video on the virtual screen when the first playback operation is received; and
display at least two bullet comments matching the first video, the at least two bullet comments comprising bullet comments transmitted by objects on the video playback platform and a gaming platform.
